(19) United States
(12) Patent Application Publication
(10) Pub. No.: US 2018/0069818 A1
(43) Pub. Date: Mar. 8, 2018

(54) MESSAGE MANAGEMENT METHOD AND MESSAGE MANAGEMENT SERVER

(71) Applicant: Gurunavi, Inc., Chiyoda-ku (JP)

(72) Inventor: Nobumichi KUNITAKE, Chiyoda-ku (JP)

(73) Assignee: Gurunavi, Inc., Chiyoda-ku (JP)

(21) Appl. No.: 15/561,199

(22) PCT Filed: Mar. 24, 2016
(86) PCT No.: PCT/IB2016/000441

§ 371 Date: Sep. 25, 2017

(30) Foreign Application Priority Data
Mar. 26, 2015 (JP) 2015-064567

(51) Int. Cl. H04L 12/58; H04L 12/18

(52) U.S. Cl. CPC H04L 51/20; H04L 12/1818; H04L 51/046

(57) ABSTRACT

A message management server and a message management method implemented by the message management server are provided. The message management method includes the steps of: selecting a venue located in a planned area corresponding to received planned area information; transmitting a message requiring participation in intergroup exchange of messages to a venue terminal of the selected venue (S201); transmitting a message requiring acceptance of participation of the selected venue in the intergroup exchange of messages to a plurality of user terminals if a participation request is received from the venue terminal of the selected venue (S205); and adding the venue terminal disposed in the selected venue to a predetermined group in which the intergroup exchange of messages is carried out if a message indicating acceptance of the participation of the selected venue in the intergroup exchange of messages is received from at least one of the plurality of user terminals (S209).

### BACKGROUND OF THE INVENTION

### 1. Field of the Invention

The invention relates to a message management server to manage transmission/reception of messages in a group to which a plurality of users belong and a message management method implemented by the message management server.

### 2. Description of Related Art

Conventionally, when a group to which a plurality of users belong holds an event, an organizer of the group may determine the details of the event and make a reservation of a venue in which the event is to be held by phone or via the website of the venue, all by him- or herself.

For example, Japanese Patent Application Publication No. 2007-304637 proposes that a customer who has published planned details of an event, including date/time, place, budget, and desired food, checks proposals presented from establishments in response to the planned details of the event on a screen of a website and then clicks a “Reserve” button corresponding to one of the proposals to make a reservation.

### SUMMARY OF THE INVENTION

It is burdensome, however, for an organizer of a group to contact a plurality of users belonging to the group to determine the details of the event, such as date/time, place, and budget, all by him- or herself.

It is therefore an object of the present application to provide a message management method and a message management server that enable a plurality of users belonging to a group that is planning to have an event and a person in charge of a venue in which the event is to be held to discuss reservation details of the venue even before details of the event are not determined yet.

A first aspect of the present invention relates to a message management method implemented by a message management server that includes a storage unit storing location information of each venue in which one of a plurality of venue terminals is disposed in association with delivery information of the plurality of venue terminals, that is capable of communicating with the plurality of venue terminals, and that manages intergroup exchange of messages on user terminals of a plurality of users belonging to a predetermined group. The message management method includes the steps of: receiving planned area information of an event held by the predetermined group from at least one of the user terminals; referencing the storage unit to select a venue located in a planned area corresponding to the planned area information; transmitting, to a venue terminal of the selected venue, a message requiring participation in the intergroup exchange of messages; transmitting, to the user terminals, a message requiring acceptance of participation of the selected venue in the intergroup exchange of messages if a participation request is received from the venue terminal of the selected venue; and adding the venue terminal disposed in the selected venue to the predetermined group in which the intergroup exchange of messages is carried out if a message indicating acceptance of the participation of the selected venue in the intergroup exchange of messages is received from at least one of the user terminals.

According to the message management method, a plurality of users belonging to a group that is planning to have an event and a person in charge of a venue in which the event is to be held can discuss reservation details of the venue even before details of the event are not determined yet.

According to the first aspect of the present invention, an upper limit may be set to the number of venue terminals added to the predetermined group.

According to the first aspect of the present invention, the upper limit set to the number of venue terminals added to the predetermined group may be one.

According to the first aspect of the present invention, the venue terminal disposed in the selected venue may be added to the predetermined group in which the intergroup exchange of messages is carried out only if a message indicating acceptance of the participation of the selected venue in the intergroup exchange of messages is received from all of the user terminals.

According to the first aspect of the present invention, an acceptance propriety message including a numerical value indicating an acceptance level may be received from at least two of the user terminals, and the venue terminal disposed in the selected venue may be added to the predetermined group if a total of the numeric values indicating the acceptance level included in the acceptance propriety messages is equal to or greater than a predetermined value.

According to the first aspect of the present invention, an acceptance propriety message including a numerical value indicating an acceptance level may be received from at least two of the user terminals, and the venue terminal disposed in the selected venue may be added to the predetermined group if an average value of the numeric values of the acceptance level included in the acceptance propriety messages is equal to or greater than a predetermined value.

A second aspect of the present invention relates to a message management method implemented by a message management server that includes a storage unit storing delivery information of user terminals of a plurality of users belonging to a predetermined group, that is capable of communicating with a plurality of venue terminals, and that manages intergroup exchange of messages on the user terminals of the plurality of users belonging to the predetermined group. The message management method includes the steps of: storing delivery information of a first venue terminal disposed in a first venue in the storage unit in association with delivery information of the user terminals of the plurality of users belonging to the predetermined group if a message indicating acceptance of participation of the first venue in the intergroup exchange of messages is received from at least one of the user terminals; further storing delivery information of a second venue terminal different from the first venue terminal and disposed in a second venue different from the first venue, in the storage unit in association with the delivery information of the user terminals of the plurality of users belonging to the predetermined group if a message indicating acceptance of participation of the second venue in the intergroup exchange of messages is received from at least one of the user terminals; and carrying out the intergroup exchange of messages based on the delivery information of the first venue terminal or the delivery information of the second venue terminal associated with the delivery information of the user terminals of the plurality of users belonging to the predetermined group. If the intergroup exchange of messages is carried out between the user terminals and the first venue terminal, a message received from the first venue terminal or a message transmitted to the first venue terminal is not transmitted to the second venue terminal.

According to the second aspect of the present invention, if the intergroup exchange of messages is carried out between the user terminals and the second venue terminal, a message received from the second venue terminal or a message transmitted to the second venue terminal may not be transmitted to the first venue terminal.

According to the second aspect of the present invention, the message management method may further include the steps of: creating a first group in which the intergroup exchange of messages is carried out between the user terminals and the first venue terminal if the delivery information of the first venue terminal disposed in the first venue is stored in association with the delivery information of the user terminals of the plurality of users belonging to the predetermined group; and creating a second group different from the first group, in which the intergroup exchange of messages is carried out between the user terminals and the second venue terminal if the delivery information of the second venue terminal disposed in the second venue is stored in association with the delivery information of the user terminals of the plurality of users belonging to the predetermined group.

According to the second aspect of the present invention, the message management method may further include a step of creating a third group different from the first group and the second group, in which the intergroup exchange of messages is carried out between the first and second venue terminals and the user terminals.

A third aspect of the present invention relates to a message management server that is capable of communicating with a plurality of venue terminals and manages intergroup exchange of messages on user terminals of a plurality of users belonging to a predetermined group. The message management server includes a communication unit that includes a communication interface circuit for transmitting/receiving data and that is configured to communicate with the user terminals or the venue terminals, a processing unit that is configured to integrally control the overall operation of the message management server, and a storage unit that is configured to store data used for processing in the processing unit, the storage unit storing location information of each venue in which one of the plurality of venue terminals is disposed in association with delivery information of the plurality of venue terminals. The processing unit receives planned area information of an event held by the predetermined group from at least one of the user terminals via the communication unit. The processing unit references the storage unit and selects a venue located in a planned area corresponding to the planned area information. The processing unit transmits, to a venue terminal of the selected venue via the communication unit, a message requiring participation in the intergroup exchange of messages. The processing unit transmits, to the user terminals via the communication unit, a message requiring acceptance of participation of the selected venue in the intergroup exchange of messages if a participation request is received from the venue terminal of the selected venue via the communication unit. The processing unit adds the venue terminal disposed in the selected venue to the predetermined group in which the intergroup exchange of messages is carried out if a message indicating acceptance of the participation of the selected venue in the intergroup exchange of messages is received from at least one of the user terminals via the communication unit.

According to the third aspect of the present invention, the processing unit may include a group message management unit configured to receive destination information and a message from the user terminals or the venue terminals via the communication unit, to reference to the storage unit, and to transmit a message to the user terminals or the venue terminals according to the delivery information corresponding to the destination information, an event creating unit configured to receive event setting information from the user terminals via the communication unit and to create an event based on the received event setting information, a reservation candidate coordinating unit configured to coordinate, between the user terminals/venue terminals and the message management server, which establishment terminal of the plurality of the venue terminals is to be added to a group in which the intergroup exchange of messages is carried out, and an event group creating unit configured to create an event group in which exchange of messages is carried out between the venue terminal added as a reservation candidate and the user terminals.

A fourth aspect of the present invention relates to a message management server that is capable of communicating with a plurality of venue terminals and manages intergroup exchange of messages on user terminals of a plurality of users belonging to a predetermined group. The message management server includes a communication unit that includes a communication interface circuit for transmitting/receiving data and is configured to communicate with the user terminals or the venue terminals, a processing unit that is configured to integrally control the overall operation of the message management server, and a storage unit that is configured to store data used for processing in the processing unit, the storage unit storing delivery information of the user terminals of the plurality of users belonging to the predetermined group. The processing unit stores delivery information of a first venue terminal disposed in a first venue in the storage unit in association with delivery information of the user terminals of the plurality of users belonging to the predetermined group if a message indicating acceptance of participation of the first venue in the intergroup exchange of messages is received from at least one of the user terminals via the communication unit. The processing unit further stores delivery information of a second venue terminal different from the first venue terminal and disposed in a second venue different from the first venue, in the storage unit in association with the delivery information of the user terminals of the plurality of users belonging to the predetermined group if a message indicating acceptance of participation of the second venue in the intergroup exchange of messages is received from at least one of the user terminals via the communication unit. The processing unit carries out the intergroup exchange of messages based on the delivery information of the first venue terminal or the delivery information of the second venue terminal associated with the delivery information of the user terminals of the plurality of users belonging to the predetermined group. The processing unit does not transmit a message received from the first venue terminal or a message transmitted to the first venue terminal via the communication unit to the second venue terminal if the intergroup exchange of messages is carried out between the user terminals and the first venue terminal.

All of the general descriptions and the detailed descriptions are provided for illustrative and descriptive purposes only, and it should be understood that, unlike the accompanying claims, these descriptions do not restrict the present invention.

The objects and effects of the present invention would be recognized and comprehended by using the structural elements and any combination thereof identified especially in the accompanying claims. The general descriptions and the detailed descriptions are provided for illustrative and descriptive purposes only and thus do not restrict the present invention described in the claims.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram illustrating an example schematic configuration of a message management system 1;

FIG. 2A is a diagram illustrating an example schematic configuration of a mobile terminal 2;

FIG. 2B is an example schematic configuration of an establishment terminal 3;

FIG. 3 is a diagram illustrating an example schematic configuration of a server 4;

FIG. 4 is a diagram illustrating an example data structure of management tables;

FIG. 5 is a diagram illustrating an example operation sequence of creating an event;

FIG. 6 is a diagram illustrating an example operation sequence of coordinating an establishment reservation candidate;

FIG. 7 is a diagram illustrating an example flow of establishment reservation candidate addition processing;

FIG. 8A is a diagram illustrating an example screen on the mobile terminal 2 transmitting an event creation request;

FIG. 8B is a diagram illustrating an example event setting screen on the mobile terminal 2;

FIG. 8C is a diagram illustrating an example friend screen on the mobile terminal 2;

FIG. 9A is a diagram illustrating an example screen on the establishment terminal 3 displaying a user group list;

FIG. 9B is a diagram illustrating an example screen on the mobile terminal 2 displaying information of establishments that can participate;

FIG. 9C is a diagram illustrating an example screen on the mobile terminal 2 requiring acceptance of participation;

FIG. 10A is a diagram illustrating an example message transmission screen on the mobile terminal 2 of a user, Hanako;

FIG. 10B is a diagram illustrating an example message transmission screen on the establishment terminal 3 of an ABC house;

FIG. 10C is a diagram illustrating an example message transmission screen on the establishment terminal 3 of an XYZ house;

FIG. 10D is a diagram illustrating an example message reception screen on the mobile terminal 2 of Hanako;

FIG. 10E is a diagram illustrating an example message reception screen on the establishment terminal 3 of the ABC house;

FIG. 10F is a diagram illustrating an example message reception screen on the establishment terminal 3 of the XYZ house; and

FIG. 11 is a diagram illustrating an example screen on the mobile terminal 2 requiring acceptance of participation in another embodiment.

### DETAILED DESCRIPTION OF EMBODIMENTS

### First Embodiment

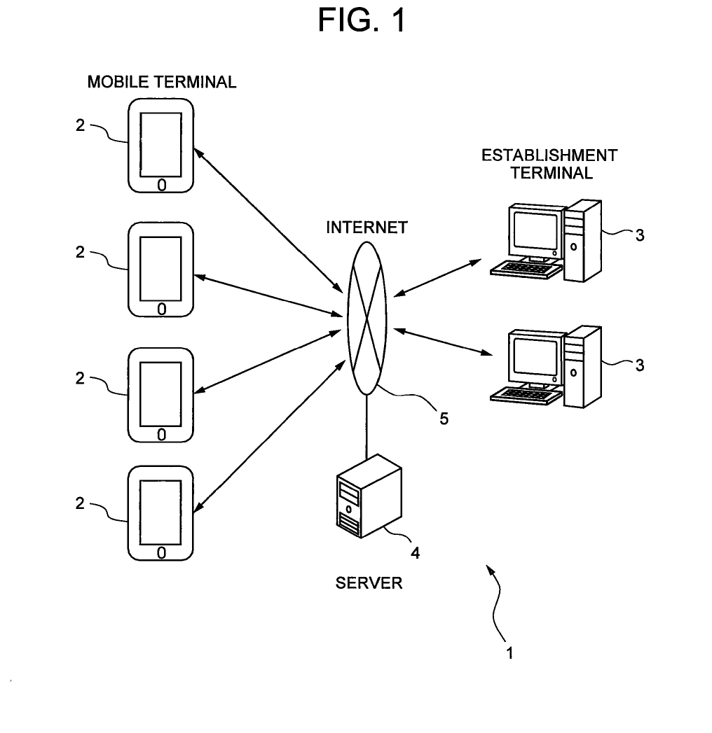

FIG. 1 is a diagram illustrating an example schematic configuration of the message management system 1.

The message management system 1 includes a plurality of mobile terminals 2, a plurality of establishment terminals 3, and a server 4. The mobile terminals 2 and the server 4 are connected to each other via a communication network such as the Internet 5. A program executed on the mobile terminals 2 and a program executed on the server 4 communicate using a communication protocol such as the Hypertext Transfer Protocol (HTTP). The establishment terminals 3 and the server 4 are connected to each other via the Internet 5, for example. A program executed on the establishment terminals 3 and a program executed on the server 4 communicate using a communication protocol such as the Hypertext Transfer Protocol (HTTP).

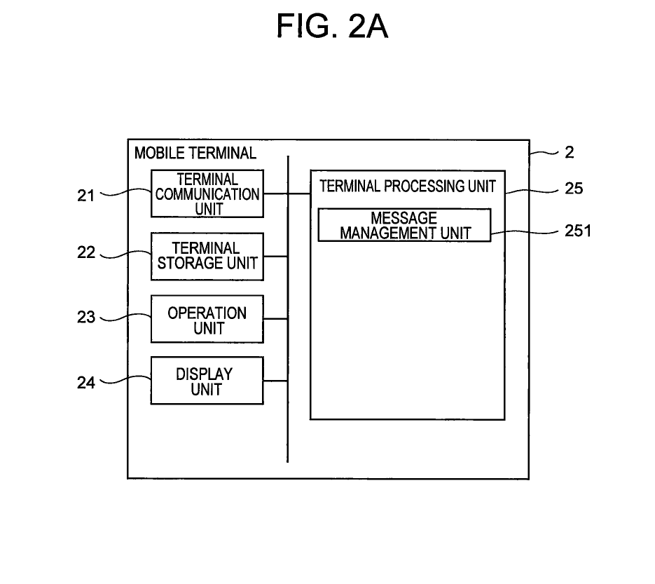

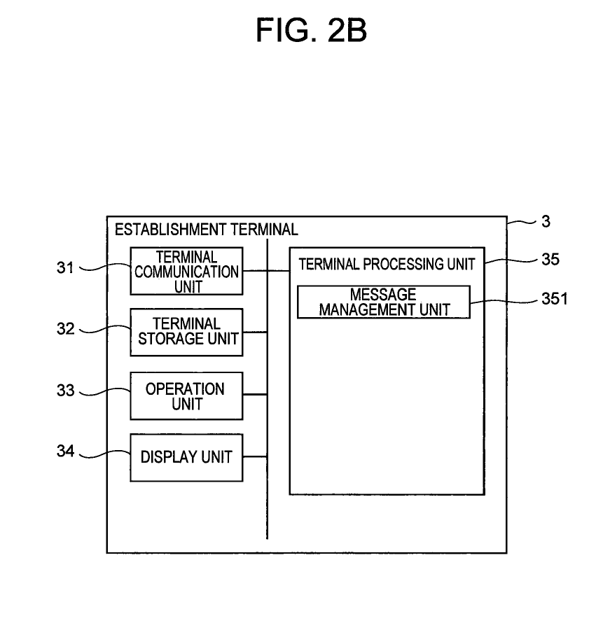

FIG. 2A is a diagram illustrating an example schematic configuration of the mobile terminal 2.

The mobile terminal 2 is an example of a user terminal and includes, for example, a terminal communication unit 21, a terminal storage unit 22, an operation unit 23, a display unit 24, and a terminal processing unit 25. The mobile terminal 2 is assumed to be, but not limited to, a multi-functional mobile phone (so-called “smartphone”). The mobile terminal 2 may be anything, including a personal computer (PC), a mobile phone (so-called “feature phone”), a personal digital assistant (PDA), and a tablet PC, as long as the present invention can be applied thereto.

The terminal communication unit 21 includes a communication interface circuit with an antenna having a predetermined frequency bandwidth as a receiving bandwidth, and, connects the mobile terminal 2 to the Internet 5. The terminal communication unit 21 transmits data supplied from the terminal processing unit 25 to the server 4 and others. Also, the terminal communication unit 21 supplies data received from the server 4 and others to the terminal processing unit 25.

The terminal storage unit 22 includes at least any one of a semiconductor memory, a magnetic disk device, and an optical disk device, for example. The terminal storage unit 22 stores an operating system program, driver programs, application programs, data, and the like used for processing in the terminal processing unit 25. For example, the terminal storage unit 22 stores an input device driver program for controlling the operation unit 23, an output device driver program for controlling the display unit 24, and the like as the driver programs. Also, the terminal storage unit 22 stores a program for carrying out intergroup exchange of messages, and the like as application programs. Also, the terminal storage unit 22 stores destination information and messages with accompanying data exchanged between groups as data. Furthermore, the terminal storage unit 22 may temporarily store data that is related to predetermined processing.

The operation unit 23 may be any device, such as a touch pad and a keyboard, as long as the device is capable of operating the mobile terminal 2. A user can use the operation unit 23 of his/her own mobile terminal 2 to input characters, numbers, and the like. When operated by a user, the operation unit 23 generates a signal corresponding to the operation by the user. The generated signal is then supplied to the terminal processing unit 25 as a user instruction.

The display unit 24 may be any device, such as a liquid crystal display and an organic EL (Electro-Luminescence) display, as long as the device is capable of displaying text, image, and the like. The display unit 24 displays, for example, a message exchanged between groups, the message being supplied from the terminal processing unit 25.

The terminal processing unit 25 includes one or more processors and a peripheral circuit of the processor(s). The terminal processing unit 25 integrally controls the overall operation of the mobile terminal 2, and is a CPU (Central Processing Unit), for example. The terminal processing unit 25 controls the operation of the terminal communication unit 21, the display unit 24, and others so that programs stored in the terminal storage unit 22 are executed by an appropriate procedure according to an operation of the operation unit 23, for example. The terminal processing unit 25 carries out processing based on programs (such as an operating system program, driver programs, and application programs) stored in the terminal storage unit 22. Moreover, the terminal processing unit 25 can execute a plurality of programs (such as application programs) in parallel.

The terminal processing unit 25 includes a message management unit 251. The message management unit 251 is a function module achieved by a program executed in a processor included in the terminal processing unit 25. Alternatively, each of these units may be implemented in the mobile terminal 2 as firmware.

The message management unit 251 carries out intergroup exchange of messages. Also, the message management unit 251 transmits setting information input by a user to the server 4. Furthermore, the message management unit 251 transmits propriety information, which is input from a user in response to a message received from the server 4, to the server 4.

FIG. 2B is an example schematic configuration of the establishment terminal 3.

The establishment terminal 3 is an example of a venue terminal and includes, for example, a terminal communication unit 31, a terminal storage unit 32, an operation unit 33, a display unit 34, and a terminal processing unit 35. A venue means a venue that is located in a planned area in which an event held by a user group to which a plurality of users belong is to be held. An event means a festival or function held by a user group to which a plurality of users belong. Examples of an event include a company trip, a new year's party, a year-end party, a barbecue, a party, a class reunion, a social gathering, and a golf competition. Examples of a venue include a hotel, a Japanese-style hotel a restaurant, a banquet hall, and a golf course. The establishment terminal 3 is assumed to be, but not limited to, a personal computer (PC). The establishment terminal 3 may be anything, including a multi-functional mobile phone (so-called “smartphone”), a mobile phone (so-called “feature phone”), a personal digital assistant (PDA), and a tablet PC, as long as the present invention can be applied thereto.

The terminal communication unit 31, the terminal storage unit 32, the operation unit 33, the display unit 34, and the terminal processing unit 35 included in the establishment terminal 3 are respectively similar to the terminal communication unit 21, the terminal storage unit 22, the operation unit 23, the display unit 24, and the terminal processing unit 25 included in the mobile terminal 2, and thus will not be described herein.

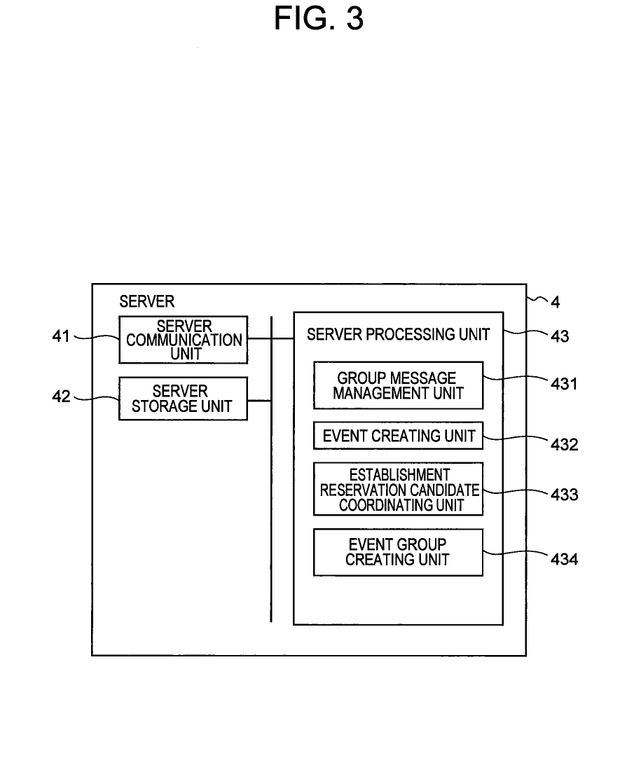

FIG. 3 is a diagram illustrating an example schematic configuration of the server 4.

The server 4 is an example of a message management server according to the present application and includes a server communication unit 41, a server storage unit 42, and a server processing unit 43. The server 4 coordinates an establishment reservation candidate in accordance with a request from the mobile terminals 2 and exchanges messages between the mobile terminal 2 of each of a plurality of users belonging to a user group and the establishment terminal 3 of the establishment reservation candidate.

The server communication unit 41 includes a communication interface circuit for transmitting/receiving data over the Internet 5, and carries out communication between the mobile terminals 2 and the server 4 and between the establishment terminals 3 and the server 4.

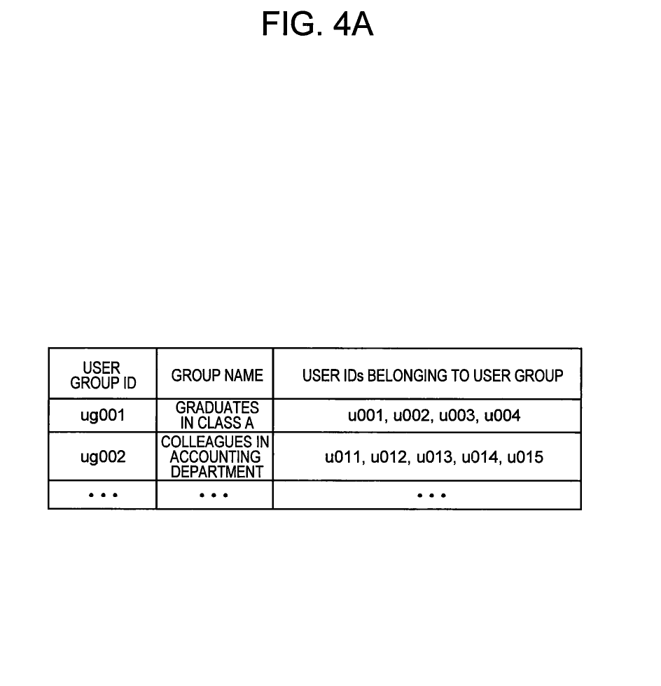

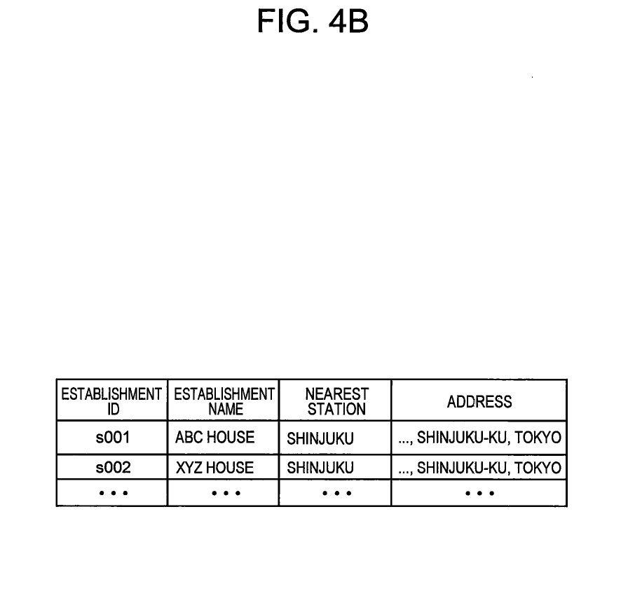

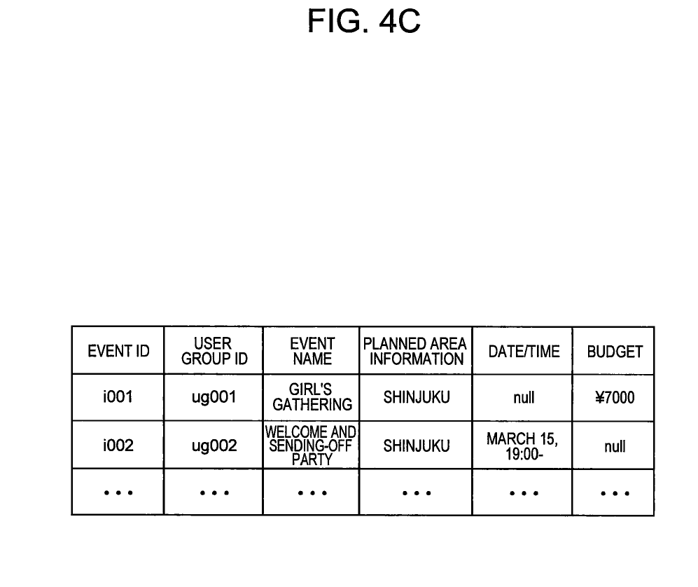

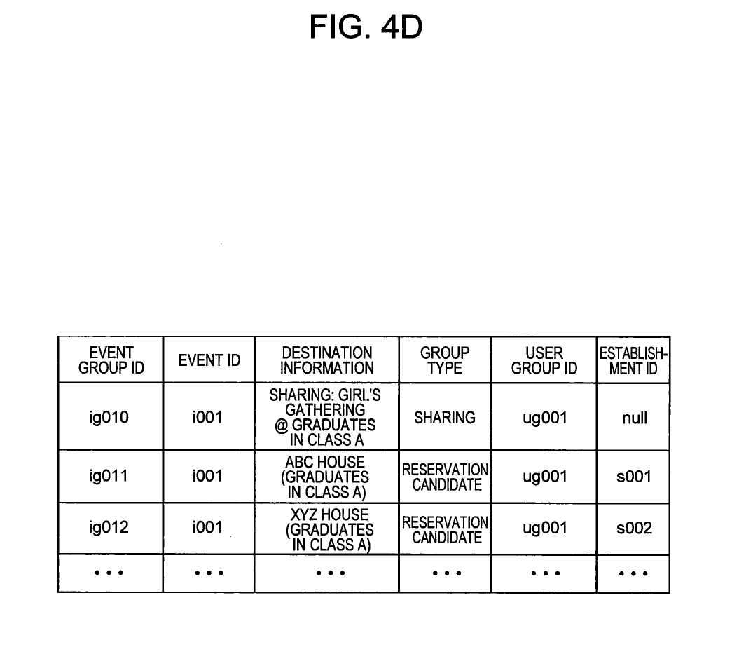

The server storage unit 42 includes at least one of a magnetic tape device, a magnetic disk device, and an optical disk device, for example, and stores an operating system program, driver programs, application programs, data, and the like used for processing in the server processing unit 43. Also, the server storage unit 42 stores a user group management table (FIG. 4A), an establishment management table (FIG. 4B), an event management table (FIG. 4C), and an event group management table (FIG. 4D) as data. Furthermore, the server storage unit 42 further includes a buffer for temporarily storing data related to predetermined processing.

The server processing unit 43 includes one or more processors and peripheral circuit(s) of the processor(s). The server processing unit 43 integrally controls the overall operation of the server 4, and includes a CPU, for example. Also, the server processing unit 43 controls operations of the server communication unit 41 and others according to appropriate procedures based on programs (such as an operating system program, driver programs, and application programs) stored in the server storage unit 42. Furthermore, the server processing unit 43 may execute a plurality of programs (such as application programs) in parallel.

The server processing unit 43 includes, for example, a group message management unit 431, an event creating unit 432, an establishment reservation candidate coordinating unit 433, and an event group creating unit 434. These are function modules achieved by programs executed in a processor included in the server processing unit 43. These function modules may be implemented in the server 4 as firmware.

The group message management unit 431 receives destination information and a message from the mobile terminal 2 or the establishment terminal 3 via the server communication unit 41, references the server storage unit 42, and transmits a message to the mobile terminal 2 or the establishment terminal 3 according to delivery information corresponding to the destination information. For example the delivery information is a login ID such as user identification information and establishment identification information. In that case, the mobile terminal 2 or the establishment terminal 3 initially logs in to the server 4 using a login ID of the mobile terminal 2 or the establishment terminal 3. Then, the group message management unit 431 transmits a message to the mobile terminal 2 or the establishment terminal 3 identified by the login ID, which is user identification information or establishment identification information, for example.

Alternatively, if the mobile terminal 2 or the establishment terminal 3 is connected to the Internet 5, the group message management unit 431 may transmit a message to the mobile terminal 2 or the establishment terminal 3 identified by the login ID via a known push notification.

The event creating unit 432 receives event setting information from the mobile terminal 2 via the server communication unit 41 and creates an event based on the received event setting information. The event setting information includes, for example, an event name, a user group, planned area information, date/time, and budget. The date/time and the budget are optional. Creation of an event will be described later.

The establishment reservation candidate coordinating unit 433 coordinates, between a plurality of the mobile terminals 2/establishment terminals 3 and the server 4, which of the plurality of the establishment terminals 3 is to be added to a group in which intergroup exchange of messages is carried out. The coordination between a plurality of the mobile terminals 2/establishment terminals 3 and the server 4 will be described later.

The event group creating unit 434 creates an event group (for example, an event sharing group or an establishment reservation candidate group) in which messages are exchanged between the establishment terminal 3 added as an establishment reservation candidate and the mobile terminal 2 of each of a plurality of users belonging to a user group. By doing so, the event group creating unit 434 adds the establishment terminal 3 added as an establishment reservation candidate to a group in which intergroup exchange of messages is carried out on the mobile terminal 2 of each of a plurality of users belonging to a user group. Creation of an event group will be described later.

FIG. 4A is a diagram illustrating an example data structure of a user group management table.

The data structure illustrated in FIG. 4A shows a set of data items associated with a user group ID stored in the server storage unit 42. The set of data items includes, for example, a group name and user IDs of users belonging to a user group. The set of data items is an example and may include other pieces of information about a user group.

FIG. 4B is a diagram illustrating an example data structure of an establishment management table.

The data structure illustrated in FIG. 4B shows a set of data items associated with an establishment ID stored in the server storage unit 42. The set of data items includes, for example, an establishment name, a nearest station, and an address. The set of data items is an example and may include other pieces of information about an establishment.

FIG. 4C is a diagram illustrating an example data structure of an event management table.

The data structure illustrated in FIG. 4C shows a set of data items associated with an event ID stored in the server storage unit 42. The set of data items includes, for example, a user group ID, an event name, a planned area of an event, date/time of an event, and a budget. The set of data items is an example and may include other pieces of information about an event.

As is shown in the first line, which includes “null” in the item “Date/Time”, and in the second line, which includes “null” in the item “Budget”, the items “Date/Time” and “Budget” are optional. The item of planned area information, on the other hand, is required for selecting an establishment.

FIG. 4D is a diagram illustrating an example data structure of an event group management table.

The data structure illustrated in FIG. 4D shows a set of data items associated with an event group ID stored in the server storage unit 42. The set of data items includes, for example, an event ID, destination information, a group type, and an establishment ID of the establishment terminal 3 of an establishment reservation candidate.

The group type represents a type of an event group and includes “Sharing”, which represents an event sharing group, or “Reservation Candidate”, which represents an establishment reservation candidate group, for example. The event sharing group is a sharing group within an event, in which messages are exchanged between all of the establishment terminals 3 of establishment reservation candidates within the event and a plurality of the mobile terminals 2 of users belonging to a user group. The first line includes “null” in the item “Establishment ID”. The establishment reservation candidate group is a group in which messages are exchanged between the establishment terminal 3 added to the establishment reservation candidate group and a plurality of the mobile terminals 2 of users belonging to a user group.

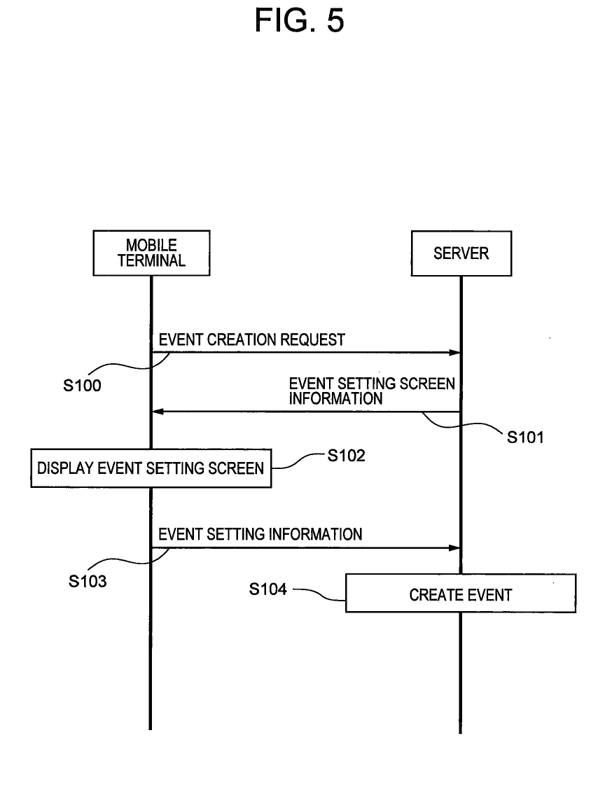

FIG. 5 is a diagram illustrating an example operation sequence of creating an event.

An operation sequence described below is mainly carried out by the terminal processing unit 25 and the server processing unit 43, in cooperation with each component of the mobile terminal 2 and the server 4, based on programs stored in advance in the terminal storage unit 22 and the server storage unit 42.

First, the message management unit 251 of the mobile terminal 2 transmits an event creation request to the server 4 via the terminal communication unit 21 (step S100).

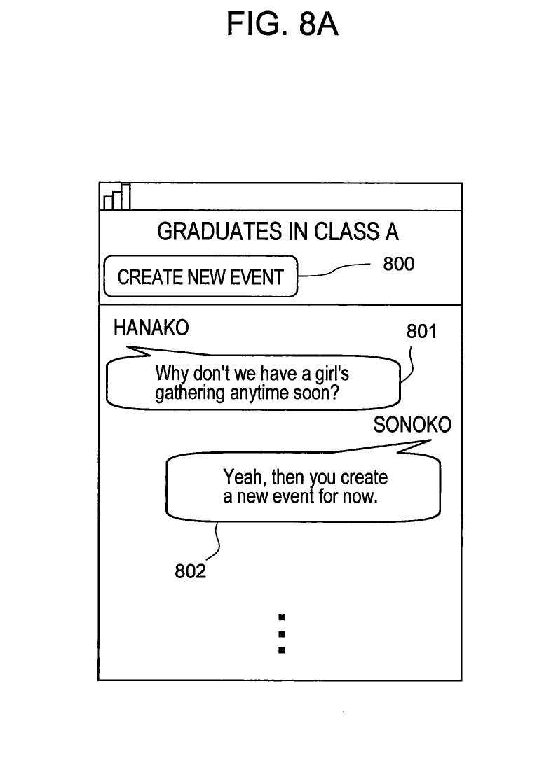

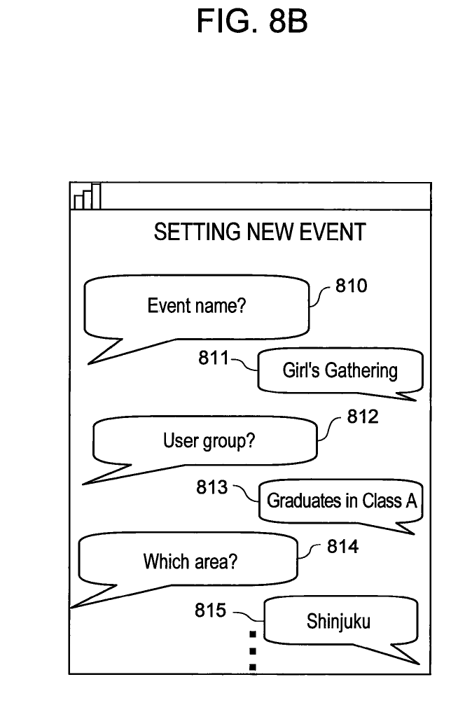

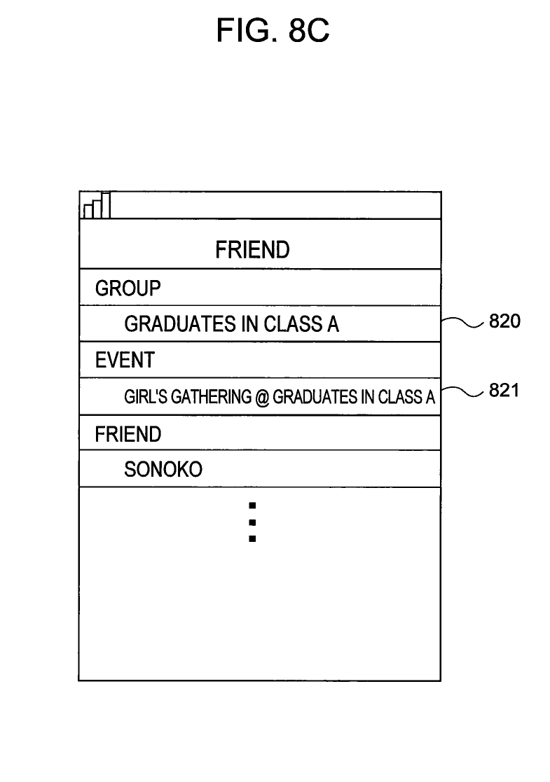

FIG. 8A is a diagram illustrating an example screen on the mobile terminal 2 transmitting an event creation request in step S100 of FIG. 5.

In FIG. 8A, Hanako and Sonoko, who are users of a plurality of the mobile terminals 2, are exchanging messages. The group name of the user group to which Hanako and Sonoko belong is Graduates in Class A. A message 801 transmitted from Hanako's mobile terminal 2 and a message 802 transmitted from Sonoko's mobile terminal 2 are displayed. Here, if Hanako selects a create new event button 800 by operating the operation unit 23, the message management unit 251 transmits an event creation request to the server 4 via the terminal communication unit 21.

Referring back to FIG. 5, when the event creation request is received via the server communication unit 41, the event creating unit 432 of the server 4 transmits event setting screen information to the mobile terminal 2 via the server communication unit 41 (step S101).

When the event setting screen information is received via the terminal communication unit 21, the message management unit 251 of the mobile terminal 2 displays an event setting screen on the display unit 24 based on the received event setting screen information (step S102). Next, when the user inputs event setting information on the event setting screen by operating the operation unit 23 of her own mobile terminal 2, the message management unit 251 transmits the event setting information input by the user to the server 4 via the terminal communication unit 21 (step S103).

FIG. 8B is a diagram illustrating an example of the event setting screen described in step S102 in FIG. 5 on the mobile terminal 2.

In FIG. 8B, the message management unit 251 of the mobile terminal 2 firstly displays a message 810, “Event name?”. Next, the message management unit 251 displays a message 811, “Girl's Gathering”, which has been input by Hanako by operating the operation unit 23. Next, the message management unit 251 displays a message 812, “User group?”. Next, the message management unit 251 displays a message 813, “Graduates in Class A”, which has been input by Hanako by operating the operation unit 23. Next, the message management unit 251 displays a message 814, “Which area?”. Next, the message management unit 251 displays a message 815, “Shinjuku”, which has been input by Hanako by operating the operation unit 23. The information input in the messages 811, 813, 815 is event setting information. The message management unit 251 transmits the event setting information input in the messages 811, 813, 815 to the server 4 via the terminal communication unit 21. Because the inquiry messages 810, 812, 814 from the message management unit 251 and event setting information needed for creating an event input by the user, Hanako, are alternatingly displayed, the user's stress from inputting information can be mitigated. Date/time or a budget may also be included in the event setting information.

Referring back to FIG. 5, when the event setting information is received via the server communication unit 41, the event creating unit 432 of the server 4 registers various information items in the event management table by associating the information items with a newly allocated event ID based on the received event setting information. This enables the event creating unit 432 of the server 4 to create an event (step S104) and to complete the operation sequence.

FIG. 8C is a diagram illustrating an example friend screen displayed by the message management unit 251 of the mobile terminal 2 after step S104 in FIG. 5.

In FIG. 8C, under a user group, Graduates in Class A 820, an event, Girl's Gathering @ Graduates in Class A 821, created by the event creating unit 432 is displayed. When a user selects the Girl's Gathering @ Graduates in Class A 821 by operating the operation unit 23 of her own mobile terminal 2, the message management unit 251 displays a screen (not shown) for exchanging messages between event groups.

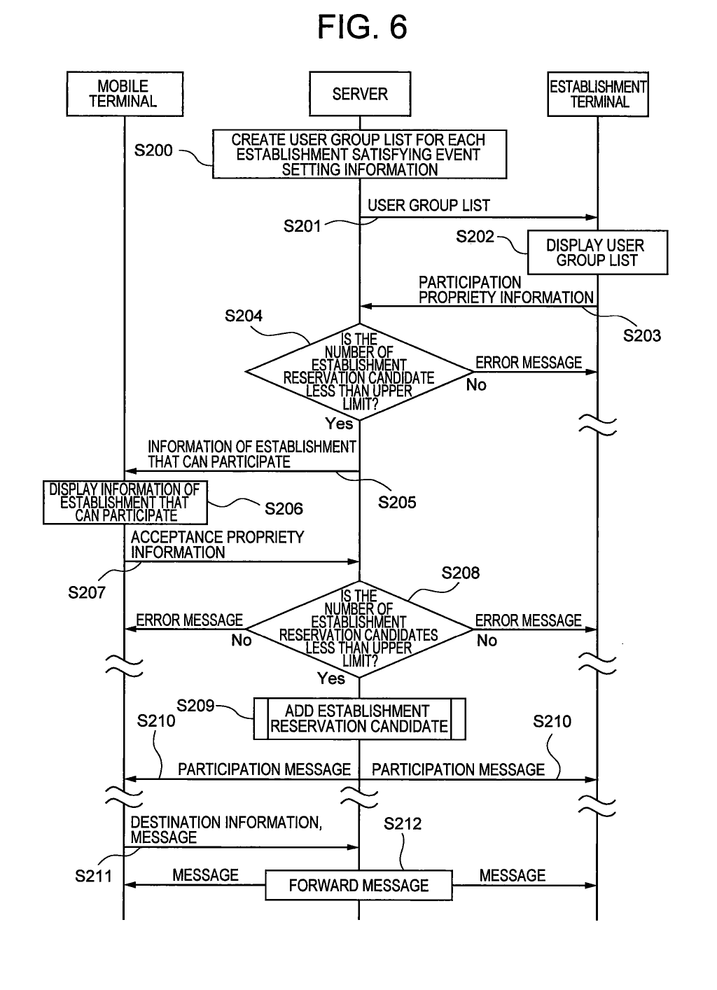

FIG. 6 is a diagram illustrating an example operation sequence of coordinating an establishment reservation candidate.

The operation sequence described below is mainly carried out by the terminal processing unit 25, the terminal processing unit 35, and the server processing unit 43 in cooperation with each component of the mobile terminal 2, the establishment terminal 3, and the server 4 based on programs stored in advance in the terminal storage unit 22, the terminal storage unit 32, and the server storage unit 42.

First, the establishment reservation candidate coordinating unit 433 of the server 4 references the event management table and the establishment management table stored in the server storage unit 42 and selects establishments located in a planned area (such as “Nearest Station” or “Address”) corresponding to the planned area information in the event setting information. Then, the establishment reservation candidate coordinating unit 433 of the server 4 creates a user group list for each of the selected establishments, wherein the same planned area information is set in each user group list (step S200). When selecting establishments, the establishment reservation candidate coordinating unit 433 of the server 4 may select establishments which can be reserved for the number of users in the user group on the “Date/Time” in the event setting information or establishments which can be reserved within the “Budget” in the event setting information.

The establishment reservation candidate coordinating unit 433 of the server 4 transmits the created user group list along with a message requesting participation in intergroup exchange of messages to the establishment terminal 3 of the selected establishment via the server communication unit 41 (step S201). When the user group list and the message requesting participation in intergroup exchange of messages are received via the terminal communication unit 31, the message management unit 351 of the establishment terminal 3 displays the received user group list and message requesting participation in intergroup exchange of messages on the display unit 34 (step S202). When a person in charge of the establishment terminal 3 selects participation propriety information for a user group in the user group list, the message management unit 351 transmits the participation propriety information for the user group to the server 4 via the terminal communication unit 31 (step S203). The participation propriety information is information indicating participation or nonparticipation. The participation propriety information may be a message indicating participation or nonparticipation.

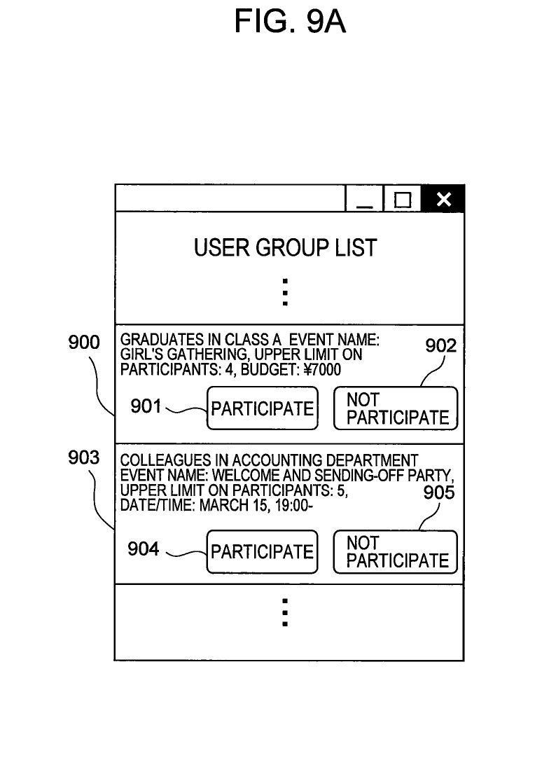

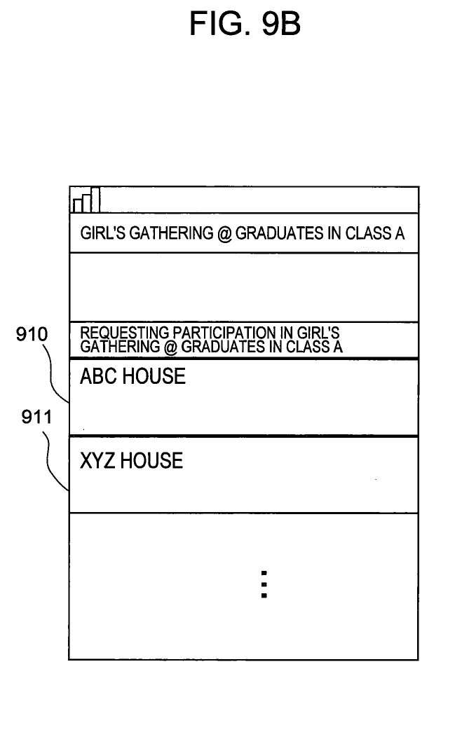

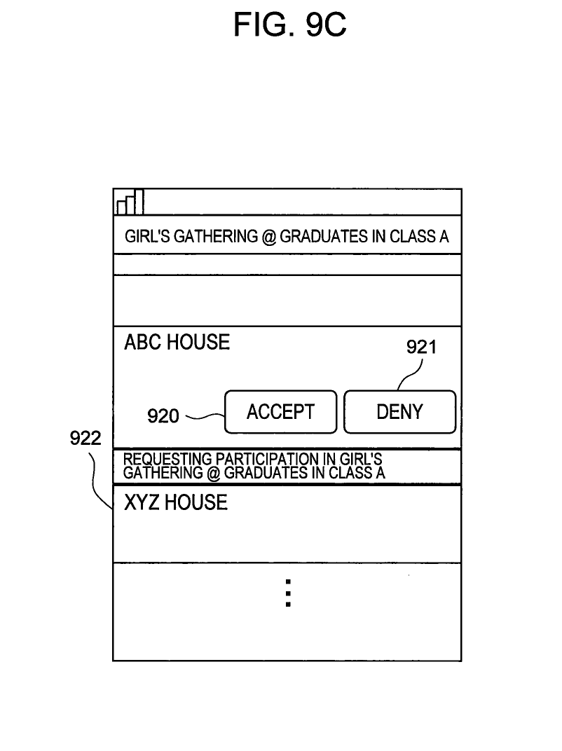

FIG. 9A is a diagram illustrating an example screen on the establishment terminal 3 displaying the user group list described in step S202 in FIG. 6.

In FIG. 9A, the user group “Graduates in Class A” and event setting information (“Event name: Girl's Gathering”, “Upper limit on participants: 4”, “Budget: ¥7000”) of the user group are displayed in a message frame 900. Because the number of users belonging to the Graduates in Class A user group is four, the upper limit of the number of participants is displayed as four. The message frame 900 also includes a participate button 901 and a not participate button 902. When the person in charge of the establishment terminal 3 selects the participate button 901 or the not participate button 902 by operating the operation unit 33, the message management unit 351 transmits the participation propriety information for the Graduates in Class A group in accordance with the selection of the participate button 901 or the not participate button 902 to the server 4 via the terminal communication unit 31. Also the user group “Colleagues in Accounting Department” and event setting information (“Event name: Welcome and sending-off party”, “Upper limit on participants: 5”, “Date/Time: March 15, 19:00-”) of the user group as well as a participate button 904 and a not participate button 905 are displayed in the message frame 903.

Referring back to FIG. 6, when the participation propriety information for the user group is received via the server communication unit 41, the establishment reservation candidate coordinating unit 433 of the server 4 determines whether the participation propriety information for the user group indicates participation or nonparticipation. If the participation propriety information of the user group indicates participation, the establishment reservation candidate coordinating unit 433 references the event group management table and determines whether a predetermined upper limit of the number of establishment reservation candidates in the event has not been reached (step S204). The predetermined upper limit of the number of establishment reservation candidates in the event indicates the upper limit of the number of the establishment terminals of the establishment reservation candidates in the event. The predetermined upper limit of the number of establishment reservation candidates in the event may also be set by a user from his/her own mobile terminal 2. If the predetermined upper limit of the number of establishment reservation candidates in the event has been reached (No in step S204), the establishment reservation candidate coordinating unit 433 transmits, via the server communication unit 41, an error message (not shown) to the establishment terminal 3 that has transmitted the participation propriety information indicating participation.

On the other hand, if the predetermined upper limit of the number of establishment reservation candidates in the event has not been reached (Yes in step S204), the establishment reservation candidate coordinating unit 433 transmits, via the server communication unit 41, information of the establishment that can participate along with a message requiring approval of the participation in the intergroup exchange of messages to a plurality of the mobile terminals 2 (step S205).

When the information of the establishment that can participate and the message requiring approval of the participation in the intergroup exchange of messages are received via the terminal communication unit 21, the message management unit 251 of each of a plurality of the mobile terminals 2 displays the received information of the establishment that can participate and the received message requiring approval of the participation in the intergroup exchange of messages on the display unit 24 (step S206). When a user inputs acceptance propriety information for the information of establishment that can participate by operating the operation unit 23 of his/her own mobile terminal 2, the message management unit 251 of each of a plurality of the mobile terminals 2 transmits acceptance propriety information input by the user for the information of the establishment that can participate to the server 4 via the terminal communication unit 21 (step S207). The acceptance propriety information is information indicating whether the participation is acceptable. The acceptance propriety information may be a message indicating whether the participation is acceptable.

FIG. 9B is a diagram illustrating an example screen on the mobile terminal 2 displaying information of establishments that can participate described in step S206 in FIG. 6.

In FIG. 9B, an ABC house 910, which is an establishment of the establishment terminal 3 that has transmitted the participation propriety information indicating participation, and an XYZ house 911, which is another establishment of the establishment terminal 3 that has transmitted the participation propriety information indicating participation, are displayed. When a user selects the ABC house 910 by operating the operation unit 23 of his/her own mobile terminal 2, the message management unit 251 displays the screen in FIG. 9C on the display unit 24.

FIG. 9C is a diagram illustrating an example screen on the mobile terminal 2 requiring acceptance of participation, the screen being displayed when a user selects the ABC house 910 in FIG. 9B.

In FIG. 9C, an accept button 920 and a deny button 921 are displayed. When a user selects the accept button 920 or the deny button 921 by operating the operation unit 23 of his/her own mobile terminal 2, the message management unit 251 transmits the acceptance propriety information corresponding to the accept button 920 or the deny button 921 that has been selected to the server 4 via the terminal communication unit 21.

Referring back to FIG. 6, when the acceptance propriety information for the information of the establishment that can participate is received via the server communication unit 41, the establishment reservation candidate coordinating unit 433 determines whether at least one piece of the acceptance propriety information for the information of the establishment that can participate from a plurality of the mobile terminals 2 indicates acceptance. If at least one piece of the acceptance propriety information for the information of the establishment that can participate from a plurality of the mobile terminals 2 indicates acceptance, the establishment reservation candidate coordinating unit 433 references the event group management table and determines whether the predetermined upper limit of the number of establishment reservation candidates in the event has not been reached (step S208). If the predetermined upper limit of the number of establishment reservation candidates in the event has been reached (No in step S208), the establishment reservation candidate coordinating unit 433 transmits, via the server communication unit 41, an error message (not shown) to each of a plurality of the mobile terminals 2 and the establishment terminal 3 that has transmitted the participation propriety information indicating participation.

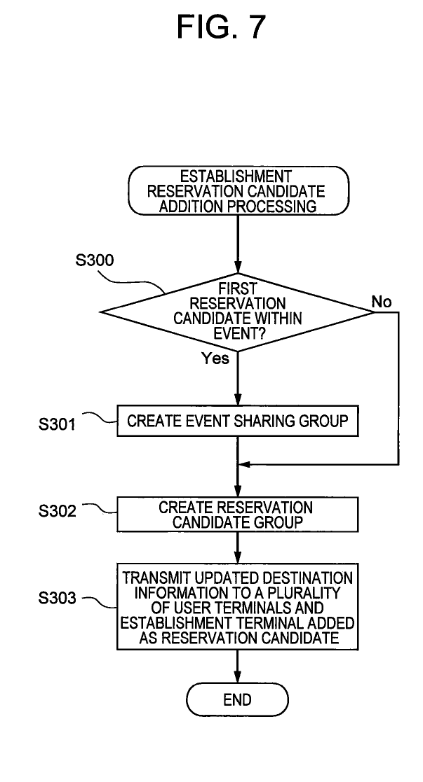

On the other hand, if the predetermined upper limit of the number of establishment reservation candidates in the event has not been reached (Yes in step S208), the event group creating unit 434 adds an establishment reservation candidate by carrying out establishment reservation candidate addition processing in FIG. 7 described below (step S209). The establishment reservation candidate coordinating unit 433 then transmits a participation message (not shown) to each of a plurality of the mobile terminals 2 via the server communication unit 41 (step S210). When the participation message is received via the terminal communication unit 21, the message management unit 251 of each of a plurality of the mobile terminals 2 displays the received participation message on the display unit 24.

Also, the establishment reservation candidate coordinating unit 433 transmits a participation message (not shown) to each of the establishment terminals 3 of the establishment reservation candidates in the event via the server communication unit 41 (step S210). When the participation message is received via the terminal communication unit 31, the message management unit 351 of each of the all establishment terminals 3 of the establishment reservation candidates in the event displays the received participation message on the display unit 34.

After step S210, a plurality of users can operate the operation unit 23 of their own mobile terminal 2 to discuss the details of the event with a person in charge of the establishment terminal 3 of the establishment reservation candidate by selecting the destination information of the event sharing group or the destination information of the establishment reservation candidate group and then transmitting a message.

When a user selects destination information, inputs a message, and presses a transmit button by operating the operation unit 23 of his/her own mobile terminal 2, the message management unit 251 transmits the destination information selected by the user and the message input by the user to the server 4 via the terminal communication unit 21 (step S211). When the destination information and the message are received via the server communication unit 41, the group message management unit 431 references the event group management table and the user group management table and transmits the message to the mobile terminal 2 and the establishment terminal 3 via the server communication unit 41 according to delivery information corresponding to the destination information (step S212).

Similarly, after step S210, a person in charge of the establishment terminal 3 of an establishment reservation candidate can operate the operation unit 33 to discuss the details of the event with users of a plurality of the mobile terminals 2 by selecting the destination information of the event sharing group or the destination information of the establishment reservation candidate group and transmitting a message.

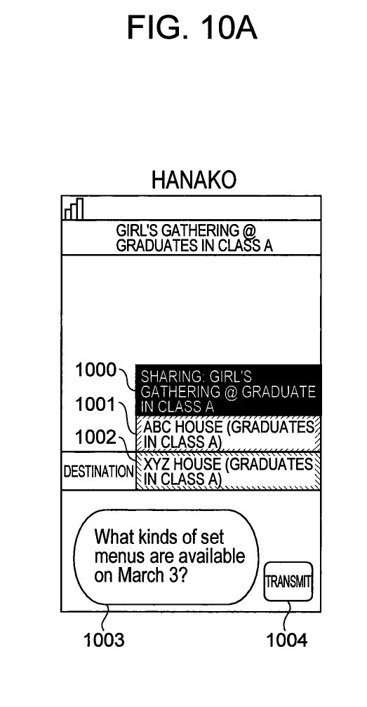

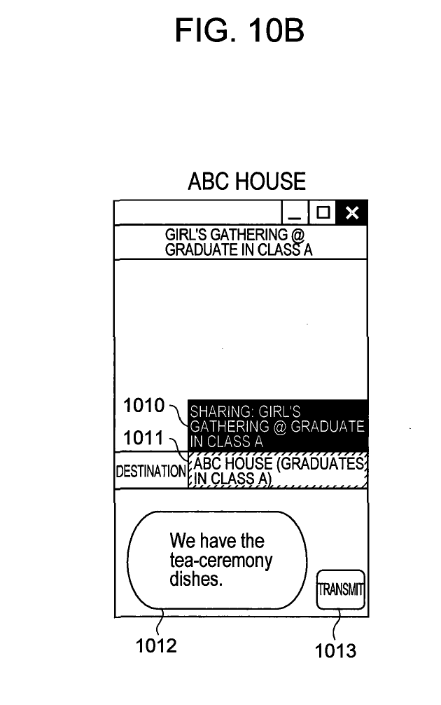

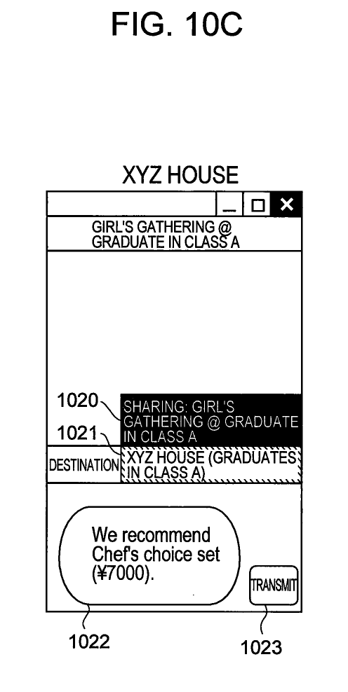

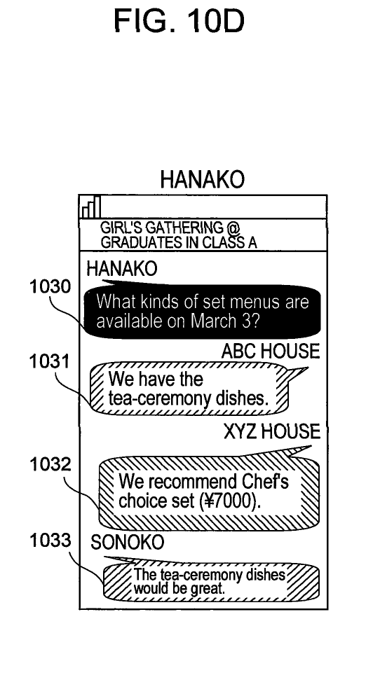

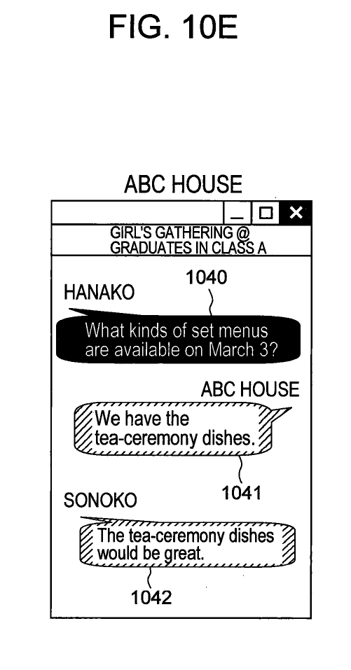

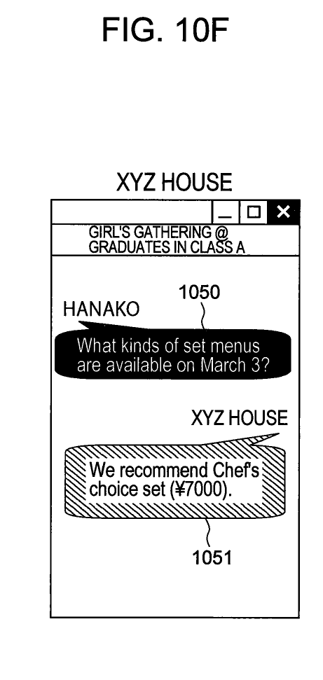

FIG. 10A is a diagram illustrating an example message transmission screen on the mobile terminal 2 of a user, Hanako.

In FIG. 10A, an event sharing group “Sharing: Girl's Gathering @ Graduates in Class A” 1000 and establishment reservation candidate groups “ABC house (Graduates in Class A)” 1001 and “XYZ house (Graduates in Class A)” 1002 are displayed as the destinations. Also, a message input form 1003 and a transmit button 1004 are displayed. This means that the establishment terminal 3 of the ABC house and the establishment terminal 3 of the XYZ house are already added as establishment reservation candidates.

Hanako selects the destination “Sharing: Girl's Gathering @ Graduates in Class A” 1000, inputs a message “What kinds of set menus are available on March 3?” in the message input form 1003, and presses the transmit button 1004 by operating the operation unit 23. This makes the message management unit 251 transmit the selected destination information “Sharing: Girl's Gathering @ Graduates in Class A” 1000 and the input message “What kinds of set menus are available on March 3?” to the server 4 via the terminal communication unit 21.

Because the destination information “Sharing: Girl's Gathering @ Graduates in Class A” 1000 is an event sharing group, the destination information enables a message to be transmitted to each of the mobile terminals 2 of a plurality of users belonging to the Graduates in Class A group and the establishment terminals 3 of all the establishment reservation candidates in the Girl's Gathering event. Because the destination information “ABC house (Graduates in Class A)” 1001 is an establishment reservation candidate group, the destination information enables a message to be transmitted to each of the mobile terminals 2 of a plurality of users belonging to the Graduates in Class A group and the establishment terminal 3 of the ABC house. Also, because the destination information “XYZ house (Graduates in Class A)” 1002 is an establishment reservation candidate group, the destination information enables a message to be transmitted to each of the mobile terminals 2 of a plurality of users belonging to the Graduates in Class A group and the establishment terminal 3 of the XYZ house.

FIG. 10B is a diagram illustrating an example message transmission screen on the establishment terminal 3 of the ABC house.

In FIG. 10B, an event sharing group “Sharing: Girl's Gathering @ Graduates in Class A” 1010 and an establishment reservation candidate group “ABC house (Graduates in Class A)” 1011 are displayed as the destinations. On the other hand, the destination of the XYZ house (Graduates in Class A) in the Girl's Gathering event is not displayed.

The person in charge of the establishment terminal 3 of the ABC house selects the destination “ABC house (Graduates in Class A)” 1011, inputs a message “We have the tea-ceremony dishes.” in a message input form 1012, and presses a transmit button 1013 by operating the operation unit 33. This makes the message management unit 351 transmit the selected destination information “ABC house (Graduates in Class A)” 1011 and the input message “We have the tea-ceremony dishes.” to the server 4 via the terminal communication unit 31.

FIG. 10C is a diagram illustrating an example message transmission screen on the establishment terminal 3 of the XYZ house.

Similarly, in FIG. 10C, an event sharing group “Sharing: Girl's Gathering @ Graduates in Class A” 1020 and an establishment reservation candidate group “XYZ house (Graduates in Class A)” 1021 are displayed as the destinations. On the other hand, the destination of the ABC house (Graduates in Class A) in the Girl's Gathering event is not displayed.

The person in charge of the establishment terminal 3 of the XYZ house selects a destination “XYZ house (Graduates in Class A)” 1021, inputs a message “We recommend Chef's choice set (¥7000).” in a message input form 1022, and presses a transmit button 1023 by operating the operation unit 33. This makes the message management unit 351 transmit the selected destination information “XYZ house (Graduates in Class A)” 1021 and the input message “We recommend Chef's choice set (¥7000).” to the server 4 via the terminal communication unit 31.

FIG. 10D is a diagram illustrating an example message reception screen on the mobile terminal 2 of Hanako after the transmissions of the messages input in the message input forms 1003, 1012, 1022 of FIGS. 10A to 10C. Also, FIG. 10E is a diagram illustrating an example message reception screen on the establishment terminal 3 of the ABC house after the transmissions of the messages input in the message input forms 1003, 1012, 1022 of FIGS. 10A to 10C. Furthermore, FIG. 10F is a diagram illustrating an example message reception screen on the establishment terminal 3 of the XYZ house after the transmissions of the messages input in the message input forms 1003, 1012, 1022 of FIGS. 10A to 10C.

In FIGS. 10D to 10F, the message with a black background color “What kinds of set menus are available on March 3?” indicated by reference numerals 1030, 1040, 1050 transmitted by Hanako to the destination “Sharing: Girl's Gathering @ Graduates in Class A” is displayed. The message “What kinds of set menus are available on March 3?” indicated by the reference numerals 1030, 1040, 1050 was transmitted to the destination “Sharing: Girl's Gathering @ Graduates in Class A”, which is an event sharing group. Therefore, the message with a black background color “What kinds of set menus are available on March 3?” indicated by the reference numerals 1030, 1040, 1050 is displayed on the message reception screen of the mobile terminal 2 of Hanako, the establishment terminal 3 of the ABC house, and the establishment terminal 3 of the XYZ house, respectively (FIGS. 10D to 10F).

As described above, each of the users of a plurality of the mobile terminals 2 or a person in charge of the establishment terminal 3 can transmit/receive messages about a common topic within the event by selecting the destination “Sharing: Girl's Gathering @ Graduates in Class A”, which is an event sharing group. For example, by selecting the destination “Sharing: Girl's Gathering @ Graduates in Class A”, which is an event sharing group, a person in charge of the establishment terminal 3 of one establishment reservation candidate can let a person in charge of the establishment terminal 3 of another establishment reservation candidate know the details of the price or food of the one establishment reservation candidate. Thus, it is possible to let a person in charge of the establishment terminal 3 of each establishment reservation candidate to offer better deal for the event.

On the other hand, the message with a right-slanted hatching “We have the tea-ceremony dishes.” indicated by reference numerals 1031, 1041 from the person in charge of the establishment terminal 3 of the ABC house was transmitted to the destination “ABC house (Graduates in Class A)”, which is an establishment reservation candidate group. Thus, the message with a right-slanted hatching “We have the tea-ceremony dishes.” indicated by the reference numerals 1031, 1041 is displayed on the message reception screen of the mobile terminal 2 of Hanako (FIG. 10D) and the message reception screen of the establishment terminal 3 of the ABC house (FIG. 10E), but is not displayed on the message reception screen of the establishment terminal 3 of the XYZ house (FIG. 10F). In other words, the message with a right-slanted hatching “We have the tea-ceremony dishes.” indicated by the reference numerals 1031, 1041 was not transmitted to the establishment terminal 3 of the XYZ house.

Also, the message with a left-slanted hatching “We recommend Chef's choice set (¥7000).” indicated by reference numerals 1032, 1051 from the person in charge of the establishment terminal 3 of the XYZ house was transmitted to the destination “XYZ house (Graduates in Class A)”, which is an establishment reservation candidate group. Thus, the message with a left-slanted hatching “We recommend Chef's choice set (¥7000).” indicated by the reference numerals 1032, 1051 is displayed on the message reception screen of the mobile terminal 2 of Hanako (FIG. 10D) and the message reception screen of the establishment terminal 3 of the XYZ house (FIG. 10F), but is not displayed on the message reception screen of the establishment terminal 3 of the ABC house (FIG. 10E). In other words, the message with a left-slanted hatching “We recommend Chef's choice set (¥7000).” indicated by the reference numerals 1032, 1051 was not transmitted to the establishment terminal 3 of the ABC house.

As described above, by selecting the destination “ABC house (Graduates in Class A)” or “XYZ house (Graduates in Class A)”, which are establishment reservation candidate groups, users of a plurality of the mobile terminals 2 and a person in charge of the establishment terminal 3 can transmit/receive messages that they don't want to show to a person in charge of the establishment terminal 3 of another establishment reservation candidate in the event.

FIG. 7 is a diagram illustrating an example flow of establishment reservation candidate addition processing of step S209 in FIG. 6.

The event group creating unit 434 of the server 4 determines whether an establishment reservation candidate of the establishment terminal 3 is the first one to be added in an event (step S300). If the establishment reservation candidate of the establishment terminal 3 is the first one to be added (Yes in step S300), the event group creating unit 434 registers various information items (such as an event ID, destination information, and a user group ID) in the event group management table in association with a newly allocated event group ID. By doing so, the event group creating unit 434 creates an event sharing group whose group type is “Sharing”. The destination information of the event sharing group is a destination with which a message is transmitted to the mobile terminal 2 of each of a plurality of users belonging to a user group and all of the establishment terminals 3 of establishment reservation candidates in the event.

On the other hand, if the establishment reservation candidate of the establishment terminal 3 is not the first one to be added (No in step S300), the event group creating unit 434 registers various information items (such as an event ID, destination information, a user group ID, and an establishment ID) in the event group management table in association with a newly allocated event group M. By doing so, the event group creating unit 434 creates an establishment reservation candidate group whose group type is “Reservation Candidate” (step S302). After step S301, the event group creating unit 434 also registers various information items (such as an event ID, destination information, a user group ID, and an establishment ID) in the event group management table in association with a newly allocated event group ID. The destination information of the establishment reservation candidate group is a destination with which a message is transmitted to the mobile terminal 2 of each of a plurality of users belonging to a user group and one establishment terminal 3 of an establishment added as an establishment reservation candidate.

The event group creating unit 434 transmits the destination information of the event sharing group registered in step S301 and/or the destination information of the establishment reservation candidate group registered in step S302 to each of the plurality of the mobile terminals 2 via the server communication unit 41 (step S303). When the destination information of the event sharing group and/or the destination information of the establishment reservation candidate group are received via the terminal communication unit 21, the message management unit 251 of each of a plurality of the mobile terminals 2 stores the received destination information of the event sharing group and/or the received destination information of the establishment reservation candidate group in the terminal storage unit 22.

The event group creating unit 434 also transmits the destination information of the event sharing group registered in step S301 and/or the destination information of the establishment reservation candidate group registered in step S302 to the establishment terminal 3 of the establishment added as an establishment reservation candidate via the server communication unit 41 (step S303). When the destination information of the event sharing group and/or the destination information of the establishment reservation candidate group are received via the terminal communication unit 31, the message management unit 351 of the establishment terminal 3 of the establishment added as an establishment reservation candidate stores the received destination information of the event sharing group and/or the received destination information of the establishment reservation candidate group in the terminal storage unit 32.

After step S303, the event group creating unit 434 completes the establishment reservation candidate addition processing. By executing the establishment reservation candidate addition processing of steps S300 to S303, the event group creating unit 434 adds the establishment terminal 3 of an establishment added as an establishment reservation candidate to the group in which intergroup exchange of messages is carried out on the mobile terminal 2 of each of a plurality of users belonging to a user group.

### Other Embodiments

In the first embodiment, the group message management unit 431 transmits a message to the mobile terminal 2 and the establishment terminal 3 by using a user ID and an establishment ID, respectively, as one example of delivery information. The group message management unit 431 may, however, transmit a message to the mobile terminal 2 or the establishment terminal 3 by using a mail address or a mailing list instead of a user ID or an establishment ID.

In the first embodiment, the establishment reservation candidate coordinating unit 433 determines whether at least one of a plurality of pieces of acceptance propriety information from a plurality of the mobile terminals 2 about information of an establishment that can participate indicates acceptance. The establishment reservation candidate coordinating unit 433 may, however, determine whether all one of a plurality of pieces of acceptance propriety information from a plurality of the mobile terminals 2 about information of an establishment that can participate indicate acceptance. This enables to add the establishment terminal 3 that has transmitted participation propriety information indicating participation as an establishment reservation candidate only when all of a plurality of users belonging to a user group accept the addition unanimously.

In the first embodiment, the establishment reservation candidate coordinating unit 433 determines whether at least one of a plurality of pieces of acceptance propriety information from a plurality of the mobile terminals 2 about information of an establishment that can participate indicates acceptance. The acceptance propriety information may, however, include a numerical value indicating an acceptance level. The numerical value indicating the acceptance level corresponds to one of steps of the acceptance level. The number of the steps of the acceptance level may be any number. In this case, the establishment reservation candidate coordinating unit 433 receives, from at least two of a plurality of the mobile terminals, the acceptance propriety information including a numerical value indicating the acceptance level and determines acceptability by determining whether the total of the numerical values indicating the acceptance level included in all of the pieces of the acceptance propriety information is equal to or higher than a predetermined value. That is, the establishment reservation candidate coordinating unit 433 determines that participation can be accepted if the total of the numerical values of the acceptance level included in all of the pieces of the acceptance propriety information is equal to or higher than a predetermined value, and determines that participation cannot be accepted if the total of the numerical values included in all of the pieces of the acceptance propriety information is less than the predetermined value.

Alternatively, the establishment reservation candidate coordinating unit 433 may determine the acceptability by receiving the acceptance propriety information including a numerical value indicating the acceptance level from at least two of a plurality of the mobile terminals and then determining whether an average value of the numerical values included in a plurality of pieces of the acceptance propriety information is equal to or higher than a predetermined value.

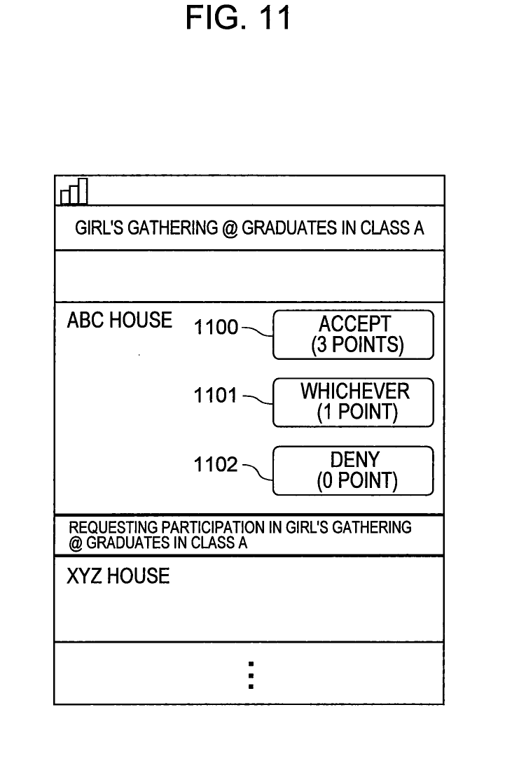

FIG. 11 is a diagram illustrating an example screen on the mobile terminal 2 requiring acceptance of participation when the acceptance propriety information includes a numerical value indicating the acceptance level.

In FIG. 11, an accept (3 points) button 1100, a whichever (1 point) button 1101, and a deny (0 point) button 1102 are displayed. The “3 points” of the accept (3 points) button 1100, the “1 point” of the whichever (1 point) button 1101, and the “0 point” of the deny (0 point) button 1102 are numerical values indicating the acceptance level. When a user selects the accept (3 points) button 1100, the whichever (1 point) button 1101, or the deny (0 point) button 1102 by operating the operation unit 23, the message management unit 251 transmits, to the server 4 via the terminal communication unit 21, acceptance propriety information including the numerical value of the acceptance level corresponding to the accept (3 points) button 1100, the whichever (1 point) button 1101, or the deny (0 point) button 1102 that has been selected.

In the first embodiment, the event group creating unit 434 creates a plurality of establishment reservation candidate groups. By doing so, the event group creating unit 434 achieves a configuration in which, when intergroup exchange of messages is carried out between a plurality of the mobile terminals 2 and a plurality of the establishment terminals 3, a message received from or transmitted to one of the establishment terminals 3 is not transmitted to another of the establishment terminals 3. The event group creating unit 434 may, however, achieve the configuration in which a message received from or transmitted to one of the establishment terminals 3 is not transmitted to another of the establishment terminals 3 by creating only one establishment reservation candidate group.

A computer program for causing a computer to achieve each function of the terminal processing unit 25, the terminal processing unit 35, and the server processing unit 43 may be provided in a form of a computer-readable recording medium, such as a magnetic storage medium and an optical storage medium, in which the computer programs are recorded.

It should be understood that a person ordinarily skilled in the art may alter, replace, or modify the present invention without departing from the spirit and scope of the present invention, and that the embodiments may be combined as needed.

1-13. (canceled)

14. A message management method implemented by a message management server that includes a storage unit storing location information of each venue in which one of a plurality of venue terminals is disposed in association with delivery information of the plurality of venue terminals, that is capable of communicating with the plurality of venue terminals, and that manages intergroup exchange of messages on user terminals of a plurality of users belonging to a predetermined group, the message management method comprising:
receiving planned area information of an event held by the predetermined group from at least one of the user terminals;
referencing the storage unit to select a venue located in a planned area corresponding to the planned area information;
transmitting, to a venue terminal of the selected venue, a message requiring participation in the intergroup exchange of messages;
transmitting, to the user terminals, a message requiring acceptance of participation of the selected venue in the intergroup exchange of messages if a participation request is received from the venue terminal of the selected venue; and
adding the venue terminal disposed in the selected venue to the predetermined group in which the intergroup exchange of messages is carried out if a message indicating acceptance of the participation of the selected venue in the intergroup exchange of messages is received from at least one of the user terminals.

15. A message management method implemented by a message management server that includes a storage unit storing delivery information of user terminals of a plurality of users belonging to a predetermined group, that is capable of communicating with a plurality of venue terminals, and that manages intergroup exchange of messages on the user terminals of the plurality of users belonging to the predetermined group, the message management method comprising:
storing delivery information of a first venue terminal disposed in a first venue in the storage unit in association with delivery information of the user terminals of the plurality of users belonging to the predetermined group if a message indicating acceptance of participation of the first venue in the intergroup exchange of messages is received from at least one of the user terminals,
further storing delivery information of a second venue terminal different from the first venue terminal and disposed in a second venue different from the first venue, in the storage unit in association with the delivery information of the user terminals of the plurality of users belonging to the predetermined group if a message indicating acceptance of participation of the second venue in the intergroup exchange of messages is received from at least one of the user terminals, and
carrying out the intergroup exchange of messages based on the delivery information of the first venue terminal or the delivery information of the second venue terminal associated with the delivery information of the user terminals of the plurality of users belonging to the predetermined group, wherein
if the intergroup exchange of messages is carried out between the user terminals and the first venue terminal, a message received from the first venue terminal or a message transmitted to the first venue terminal is not transmitted to the second venue terminal.

16. A message management server that is capable of communicating with a plurality of venue terminals and manages intergroup exchange of messages on user terminals of a plurality of users belonging to a predetermined group, comprising:
a communication unit that includes a communication interface circuit for transmitting/receiving data and that is configured to communicate with the user terminals or the venue terminals;
a processing unit that is configured to integrally control the overall operation of the message management server; and
a storage unit that is configured to store data used for processing in the processing unit, the storage unit storing location information of each venue in which one of the plurality of venue terminals is disposed in association with delivery information of the plurality of venue terminal, wherein
the processing unit receives planned area information of an event held by the predetermined group from at least one of the user terminals via the communication unit,
the processing unit references the storage unit and selects a venue located in a planned area corresponding to the planned area information,
the processing unit transmits, to a venue terminal of the selected venue via the communication unit, a message requiring participation in the intergroup exchange of messages,
the processing unit transmits, to the user terminals via the communication unit, a message requiring acceptance of participation of the selected venue in the intergroup exchange of messages if a participation request is received from the venue terminal of the selected venue via the communication unit, and
the processing unit adds the venue terminal disposed in the selected venue to the predetermined group in which the intergroup exchange of messages is carried out if a message indicating acceptance of the participation of the selected venue in the intergroup exchange of messages is received from at least one of the user terminals via the communication unit.

17. A message management server that is capable of communicating with a plurality of venue terminals and manages intergroup exchange of messages on user terminals of a plurality of users belonging to a predetermined group, comprising:
a communication unit that includes a communication interface circuit for transmitting/receiving data and is configured to communicate with the user terminals or the venue terminals;
a processing unit that is configured to integrally control the overall operation of the message management server; and
a storage unit that is configured to store data used for processing in the processing unit, the storage unit storing delivery information of the user terminals of the plurality of users belonging to the predetermined group, wherein
the processing unit stores delivery information of a first venue terminal disposed in a first venue in the storage unit in association with delivery information of the user terminals of the plurality of users belonging to the predetermined group if a message indicating acceptance of participation of the first venue in the intergroup exchange of messages is received from at least one of the user terminals via the communication unit,
the processing unit further stores delivery information of a second venue terminal different from the first venue terminal and disposed in a second venue different from the first venue, in the storage unit in association with the delivery information of the user terminals of the plurality of users belonging to the predetermined group if a message indicating acceptance of participation of the second venue in the intergroup exchange of messages is received from at least one of the user terminals via the communication unit,
the processing unit carries out the intergroup exchange of messages based on the delivery information of the first venue terminal or the delivery information of the second venue terminal associated with the delivery information of the user terminals of the plurality of users belonging to the predetermined group, and
the processing unit does not transmit a message received from the first venue terminal or a message transmitted to the first venue terminal via the communication unit to the second venue terminal if the intergroup exchange of messages is carried out between the user terminals and the first venue terminal.

18. The message management method according to claim 14, wherein an upper limit is set to the number of venue terminals added to the predetermined group.

19. The message management method according to claim 18, wherein the upper limit set to the number of venue terminals added to the predetermined group is one.

20. The message management method according to claim 14, wherein the venue terminal disposed in the selected venue is added to the predetermined group in which the intergroup exchange of messages is carried out only if a message indicating acceptance of the participation of the selected venue in the intergroup exchange of messages is received from all of the user terminals.

21. The message management method according to claim 14, wherein an acceptance propriety message including a numerical value indicating an acceptance level is received from at least two of the user terminals, and the venue terminal disposed in the selected venue is added to the predetermined group if a total of the numeric values indicating the acceptance level included in the acceptance propriety messages is equal to or greater than a predetermined value.

22. The message management method according to claim 14, wherein an acceptance propriety message including a numerical value indicating an acceptance level is received from at least two of the user terminals, and the venue terminal disposed in the selected venue is added to the predetermined group if an average value of the numeric values of the acceptance level included in the acceptance propriety messages is equal to or greater than a predetermined value.

23. The message management method according to claim 15, wherein, if the intergroup exchange of messages is carried out between the user terminals and the second venue terminal, a message received from the second venue terminal or a message transmitted to the second venue terminal is not transmitted to the first venue terminal.

24. The message management method according to claim 15, further comprising the steps of:
creating a first group in which the intergroup exchange of messages is carried out between the user terminals and the first venue terminal if the delivery information of the first venue terminal disposed in the first venue is stored in association with the delivery information of the user terminals of the plurality of users belonging to the predetermined group; and
creating a second group different from the first group, in which the intergroup exchange of messages is carried out between the user terminals and the second venue terminal if the delivery information of the second venue terminal disposed in the second venue is stored in association with the delivery information of the user terminals of the plurality of users belonging to the predetermined group.

25. The message management method according to claim 9, further comprising a step of creating a third group different from the first group and the second group, in which the intergroup exchange of messages is carried out between the first and second venue terminals and the user terminals.

26. The message management server according to claim 16, wherein the processing unit comprises:
a group message management unit configured to receive destination information and a message from the user terminals or the venue terminals via the communication unit, to reference the storage unit, and to transmit a message to the user terminals or the venue terminals according to the delivery information corresponding to the destination information;
an event creating unit configured to receive event setting information from the user terminals via the communication unit and to create an event based on the received event setting information;
a reservation candidate coordinating unit configured to coordinate, between the user terminals/venue terminals and the message management server, which venue terminal of the plurality of the venue terminals is to be added to a group in which the intergroup exchange of messages is carried out; and
an event group creating unit configured to create an event group in which exchange of messages is carried out between the venue terminal added as a reservation candidate and the user terminals.
